(19) United States
(12) Patent Application Publication
(10) Pub. No.: US 2002/0098827 A1
(43) Pub. Date: Jul. 25, 2002

(54) Charge advice in a mobile telecommunications system

(76) Inventor: Patrik Nilsson, Herzogenrath (DE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 10/056,614

(22) Filed: Jan. 24, 2002

(30) Foreign Application Priority Data
Jan. 25, 2001 (GB) 0102040.3

(51) Int. Cl. H04M 11/00

(52) U.S. Cl. 455/406; 455/407; 455/408

(57) ABSTRACT

A method of providing charge information to a mobile station 3 prior to the completion of a connection involving the mobile station 3. The method comprises, during the setup phase of the connection, sending one or more CAI elements from the mobile telecommunications network with which the mobile station 3 is registered, to the mobile station. A cost for the connection, based on the CAI element(s), is presented to the user of the mobile station 3. The user is given an opportunity to abort the connection setup prior to completion of the setup.

### FIELD OF THE INVENTION

The present invention relates to charge advice in mobile telecommunications system and in particular to a mechanism for providing charge advice to a mobile subscriber prior to completion of a chargeable event.

### BACKGROUND TO THE INVENTION

There currently exist mechanisms for providing to a subscriber of a mobile telephone network estimates of charges incurred in respect of an ongoing or completed call. In particular, for GSM networks, a service known as Advice of Charge (AoC) is available and relies upon the network periodically sending to a mobile station (MS) Charge Advice Information (CAI) elements—as defined in GSM TS 02.24. The MS is able to compute and display (estimated) charges based upon the received CAI elements. Future third generation networks will also provide for AoC services (e.g. CAI elements are already specified for UMTS networks—3GPP TS 22.024). According to 3GPP, a CAI message carries one or more of seven possible CAI elements from the MSC to the MS.

### SUMMARY OF THE PRESENT INVENTION

A significant disadvantage of the current and proposed AoC services is that they provide charge information to a subscriber only after a charge has been incurred. AoC services do not provide charge information in advance of a charge being incurred. Such information would be useful to subscribers in order to allow them to decide whether or not to establish a connection (or use a service) and hence incur a charge.

It is an object of the present invention to overcome the disadvantage of current charge advice services. This and other objects are achieved by enabling the sending of CAI elements to a MS prior to completion of a connection between the MS and a third party. According to a first aspect of the present invention there is provided a method of providing charge information to a mobile station prior to the completion of a connection involving the mobile station, the method comprising:

during the setup phase of the connection, sending one or more CAI elements from the mobile telecommunications network with which the mobile station is registered, to the mobile station;

presenting a cost for the connection based on the CAI element(s) to the user of the mobile station; and

giving the user an opportunity to abort the connection setup prior to completion of the setup.

Where the connection is initiated by the mobile station, said CAI element(s) may be sent to the mobile station, and the user given an opportunity to abort the setup, prior to the sending of an Initial Address Message (IAM) from the switching centre which receives the connection setup request from the station, to the switching centre responsible for the terminating node.

The CAI element(s) may be included in a CALL_PROCEED or FACILITY message sent from the switching centre responsible for the mobile station to the mobile station during an initial phase of the connection setup. A decision by the user to abort the connection may be carried to the switching centre in an DISCARD message.

Where the connection is initiated by a third party, said CAI element(s) may be sent to the mobile station and the user given an opportunity to abort the setup, following the receipt of an Initial Address Message (IAM) at the switching centre responsible for the mobile station and prior to the sending of an Answer message (ANM) from that switching centre to the switching centre responsible for said third party.

For both mobile station and third party initiated connections, a timer may be used at the mobile station or at the serving MSC. The timer provides a fixed time period during which the user may select to abort and/or continue with the connection setup, after which a default action is taken. For example, for a mobile station initiated connection, if no user instruction to abort the connection is received upon expiry of the timer, the connection setup may be completed.

According to a second aspect of the present invention there is provided a switching centre of a mobile telecommunications network, the switching centre comprising:

input means for receiving a connection setup request involving a mobile station registered with the switching centre;

means for sending one or more CAI elements to the mobile station relating to the proposed connection in response to receipt of a request; and

means for receiving a connection setup continue and/or abort instruction from the mobile station.

According to a third aspect of the present invention there is provided a mobile station for use in a mobile telecommunications network, the station comprising:

means for initiating a connection and for receiving an incoming call alert;

means for receiving one or more CAI elements from said network following initiation of a connection by the mobile station and/or receipt of a call set up alert, and prior to completion of the connection; and

means for sending a connection setup continue and/or abort instruction to the mobile network.

### BRIEF DESCRIPTION OF THE DRAWINGS

FIG. 1 illustrates a communication system comprising a mobile telecommunications network;

FIG. 2 is a signalling diagram illustrating a flow of signalling information in a part of the system of FIG. 1; and

FIG. 3 is a flow diagram illustrating a method of setting up a connection in the system of FIG. 1.

### DETAILED DESCRIPTION OF CERTAIN EMBODIMENTS

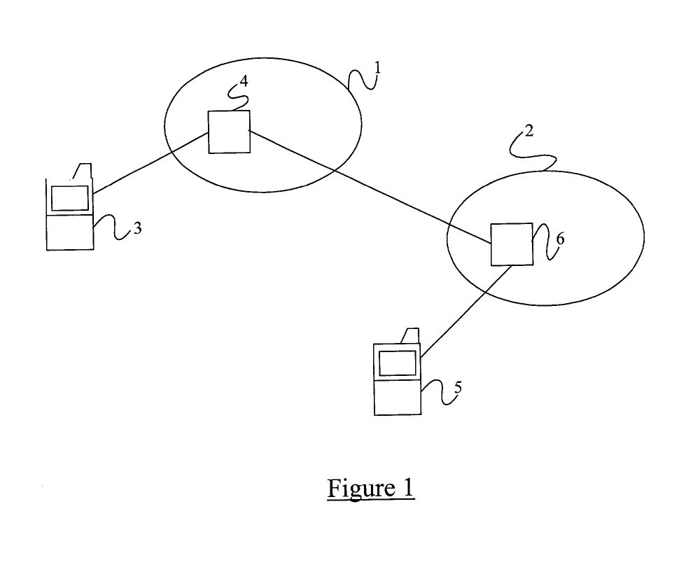

A communications system is illustrated schematically in FIG. 1. The system comprises two Public Land Mobile Networks (PLMNs) 1,2. The two networks may be directly interconnected, or may be interconnected by a trunk network and/or one or more intermediate networks (not shown in FIG. 1). A first of the PLMNs 1 serves mobile subscribers having wireless mobile stations (MSs), such as the MS 3. MSs are registered with a switching centre 4 within the PLMN. In the case of a GSM PLMN, the switching centre is a Mobile Switching Centre (MSC). The second PLMN 2 serves subscribers having MSs such as MS 5. Each MS is registered with an MSC 6.

Within the PLMN 1, a number of subsystems can be identified as follows:

Base Station Subsystem (BSS)

The BSS is responsible for the radio connections to MSS.

Mobile Services Subsystem (NSS)

This MSS is responsible for communicating with mobile stations registered with the MSC.

Traffic Control Subsystem (TCS)

The TCS is responsible for called party number (i.e. B-number) analysis including that required to route calls.

Charging Subsystem (CHS)

The CHS is responsible for charging and for supplying charge information on demand. The CHS has access to subscriber and tariff databases, and provides charging information associated with specific connections to a data store (e.g. for the later generation of Charging Data Records (CDRs).

Trunk and Signalling Subsystem (TSS).

The TSS connects the PLMN to the outside world, including trunk connections to other PLMNs and PSTNs. In this example, the TSS communicates with a peer TSS of the second PLMN 2.

All of the above subsystems may be implemented in the MSC. Alternatively however certain of the subsystems may be implemented in discrete nodes or by a combination of the MSC and discrete nodes.

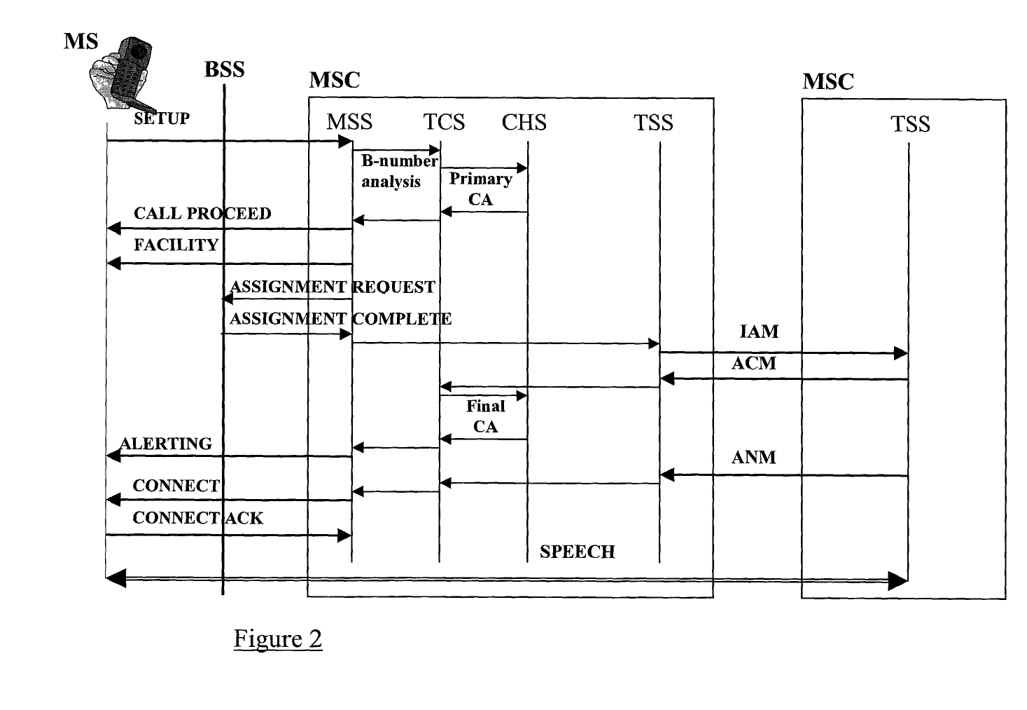

FIG. 2 illustrates the flow of signalling between the various subsystems in the event of a call setup message (SETUP) being received by the MSS (i.e. at the MSC 4) from the MS 3. FIG. 2 also illustrates the flow of signalling information between the MSS and the MS and between the TSS and the trunk connection to the peer TSS of the second PLMN. For the purpose of the following discussion, it is assumed that the connection requested by the MS 3 is a voice connection to the MS 5.

Following receipt of the setup message by the MSS, the A and B-numbers associated with the connection are passed to the TCS. The TCS determines the necessary routing information, and notifies the CHS which creates a record for the connection. A primary CA message sent from the TCS to the CHS results in the CHS identifying the CAI element(s) which will be used to charge for the connection. During this process, the MSS authenticates and authorises the MS. A CALL_PROCEED message is then sent from the MSS to the MS. This message may inform the MS of certain parameters to be used for the connection. The MSS then sends an ASSIGN_REQUEST message to the BSS, requesting appropriate resources for the connection. Assuming that the BSS can provide the requested resources, it responds by sending an ASSIGN_COMPLETE message to the MSS.

Following completion of this exchange, the MSS causes the TSS to send an Initial Address Message (IAM) to the TSS (located in the MSC 6) associated with the B-subscriber. The IAM may be routed between one or more intermediate exchanges, and causes circuits to be seized for the requested connection.

When the IAM reaches the MSC 6, the MS 5 begins to ring. At this point, an Address Complete Message (ACM) is returned to the TSS of the MSC 4 from the TSS of the MSC 6, and is delivered to the TCS. In some circumstances, the ACM may contain additional charge information (inserted by the exchange 6 and or by an intermediate exchange). If so, then the TCS may issue a Final CA instruction to the CHS to cause the CAI elements used for the connection to be re-evaluated. This is however an unusual occurrence. Further signalling follows, including the sending of an ANM from the MSC 6 to the TCS of the MSC 4 (via the TSS), when the B-subscriber answers. The TCS notifies the CHS of this event, whereupon the CHS commences charging. Further ALERTING and CONNECT messages are exchanged between the MS 3 and the MSS after which the connection is fully established.

Following the sending of the primary CA message from the TCS to the CHS, preliminary CAI elements are available for the connection. These will be used for charging the call unless modified charge information is received in the ACM. At worst, the CAI elements can be used to estimate call charges.

It is desirable to notify a subscriber, in this case the user of the MS 3, of future charges prior to alerting the B-subscriber. This requires that the CAI elements be sent to the MS 3 prior to the sending of the IAM from the MSC. This may be achieved by incorporating the (preliminary) CAI elements into either the CALL_PROCEED message sent from the MSS to the MS 3, or in a FACILITY message (GSM 04.80, 04.10). This may of course require changes to be made to the relevant protocols which define these messages. Alternatively, new messages may be defined for carrying the CAI elements.

Assume by way of example that a FACILITY message carries the CAI elements to the MS 3. Upon sending of the message, the MSS commences a timer. This may have a value of say 5 seconds. Upon receipt of the FACILITY message, the MS 3 computes the call tariff for the requested connection using the CAI elements (if the CAI elements themselves do not represent the tariff), and displays this on the MS's display. The tariff may also or alternatively be spoken to the user using a voice synthesiser. The user then has the option to abort the connection setup by pressing a key of the MS 3. This option exists for the period for which the MSS timer runs. If the termination option is selected, a setup cancel message is returned to the MSS. This message may be the DISCONNECT message triggered by the user pressing the “No” or “cancel” button on his terminal. This causes the MSS to cancel the sending of the LAM. The Bsubscriber's mobile station does not ring. If on the other hand the user does not select to abort the connection set-up, upon expiry of the timer, the MSS causes the IAM to be sent, in turn causing the B-subscriber's MS 5 to ring.

Assuming that the subscriber has not aborted the setup, the IAM will be sent and the ACM returned. If the ACM contains additional charge information, resulting in the recomputing of the CAI elements, the MS 3 may be informed by the sending of a further FACILITY message or CONNECT message, and a new tariff computed and displayed. At this point, the subscriber may still cancel the connection but by this point of course the B-subscriber' MS 5 has already rung and such an action may be annoying to the B-subscriber.

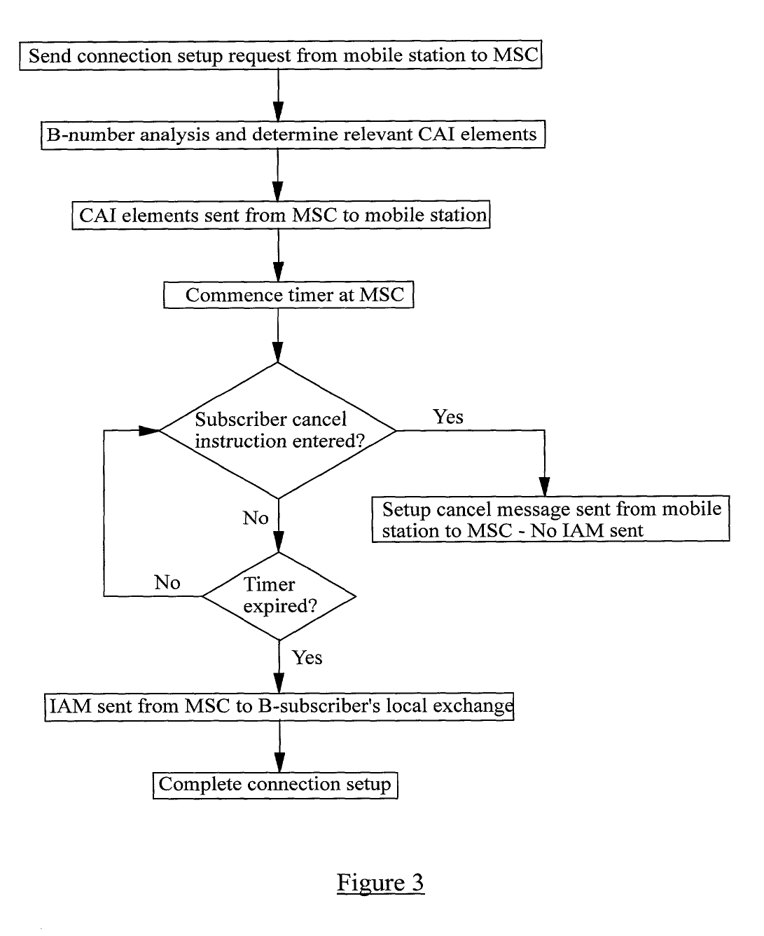

In order to further illustrate the method described above, reference is made to the flow diagram of FIG. 3.

It will be appreciated by the person of skill in the art that various modifications may be made to the above described embodiments without departing from the scope of the present invention. For example, the present invention may be employed for connections to a mobile station initiated by a third party, where a charge will be made to the mobile subscriber's account (e.g. a reverse charges call). This third party may be another subscriber, or could be a node within a telecommunications network. The present invention not only applies to voice connections, but equally to other connections including data connections. Furthermore, whilst the above description has been concerned with GSM networks, the invention is applicable to other network types including UMTS (3GPP) networks.

1. A method of providing charge information to a mobile station prior to the completion of a connection involving the mobile station, the method comprising:
during the setup phase of the connection, sending one or more CAI elements from the mobile telecommunications network with which the mobile station is registered, to the mobile station;
presenting a cost for the connection based on the CAI element(s) to the user of the mobile station; and
giving the user an opportunity to abort the connection setup prior to completion of the setup.

2. A method according to claim 1, wherein the connection is initiated by the mobile station, and said CAI element(s) is/are sent to the mobile station and the user given an opportunity to abort the setup, prior to the sending of an Initial Address Message (IAM) from the switching centre which receives the connection setup request from the station, to the switching centre responsible for the terminating node.

3. A method according to claim 1, wherein the connection is initiated by a third party, and said CAI element(s) being sent to said mobile station and the user given an opportunity to abort the setup, following the receipt of an Initial Address Message (IAM) at the switching centre responsible for the mobile station and prior to the sending of an Answer message (ANM) from that switching centre to the switching centre responsible for said third party.

4. A method according to claim 1, wherein the CAI element(s) is/are included in a CALL_PROCEED or FACILITY message sent from the switching centre responsible for the mobile station to the mobile station during an initial phase of the connection setup.

5. A method according to claim 1, wherein a decision by the user to abort the connection is carried to the switching centre in a DISCONNECT message.

6. A method according to claim 1 and comprising using a timer at the mobile station or at the serving switching centre, the timer providing a fixed time period during which the user may select to abort and/or continue with the connection setup, after which a default action is taken.

7. A switching centre of a mobile telecommunications network, the switching centre comprising:
input means for receiving a connection setup request involving a mobile station registered with the switching centre;
means for sending one or more CAI elements to the mobile station relating to the proposed connection in response to receipt of a request; and
means for receiving a connection setup continue and/or abort instruction from the mobile station.

8. A mobile station for use in a mobile telecommunications network, the station comprising:
means for initiating a connection and for receiving an incoming call alert;
means for receiving one or more CAI elements from said network following initiation of a connection by the mobile station and/or receipt of a call set up alert, and prior to completion of the connection; and
means for sending a connection setup continue and/or abort instruction to the mobile network.
